(19) United States
(12) Patent Application Publication
(10) Pub. No.: US 2018/0088846 A1
(43) Pub. Date: Mar. 29, 2018

(54) MULTI-USER DYNAMIC STORAGE ALLOCATION AND ENCRYPTION

(71) Applicant: Seagate Technology LLC, Longmont, CO (US)

(72) Inventors: Stacey Secatch, Longmont, CO (US); Robert Wayne Moss, Longmont, CO (US); Dana Lynn Simonson, Owatonna, MN (US); Kristofer Carlson Conklin, Burnsville, MN (US); Thomas Roy Prohofsky, Longmont, CO (US)

(21) Appl. No.: 15/277,199

(22) Filed: Sep. 27, 2016

(51) Int. Cl. G06F 3/06; G06F 21/60; H04L 29/06

(52) U.S. Cl. CPC G06F 3/0623; G06F 3/0631; G06F 3/0659; H04L 63/08; G06F 3/067; G06F 21/602; G06F 3/0665

(57) ABSTRACT

Systems and methods presented herein provide for data storage for a plurality of host systems. In one embodiment, a storage system comprises a storage unit, and a controller. The controller is operable to process a write I/O request from a first of the host systems, to determine an identity of the first host system from the write I/O request, to encrypt data of the write I/O request based on the identity of the first host system, to locate a storage space allocated to the first host system in the storage unit, to determine that a size of the data of the write I/O request requires more storage space than currently allocated to the first host system, to increase the storage space allocated to the first host system by the size of the data of the write I/O request, and to write the encrypted data to the storage unit.

### BACKGROUND

Information technology continues to evolve at a dizzying pace. Once, several operators worked on terminals of a mainframe computer system. Now, the concept of cloud computing abstracts data storage and processing away from a computing device. For example, cloud computing provides shared computer processing resources and data to computers and other devices on demand. The shared computing resources can be rapidly provisioned and released.

This sharing comes with a security risk. For example, when multiple people access the same data storage resources, one person may inadvertently access data belonging to another person. Or, a nefarious actor may intentionally retrieve private data belonging to another person. In whatever case, security features need to be implemented to ensure that data belonging to one person is not accessed by another without permission.

### SUMMARY

Systems and methods presented herein provide for data storage for a plurality of host systems. In one embodiment, a storage system comprises a storage unit, and a controller. The controller is operable to process a write Input/Output (I/O) request from a first of the host systems, to determine an identity of the first host system from the write I/O request, to encrypt data of the write I/O request based on the identity of the first host system, to locate a storage space allocated to the first host system in the storage unit, to determine that a size of the data of the write I/O request requires more storage space than currently allocated to the first host system, to increase the storage space allocated to the first host system by the size of the data of the write I/O request, and to write the encrypted data to the storage unit.

The various embodiments disclosed herein may be implemented in a variety of ways as a matter of design choice. For example, some embodiments herein are implemented in hardware whereas other embodiments may include processes that are operable to implement and/or operate the hardware. Other exemplary embodiments, including software and firmware, are described below.

### BRIEF DESCRIPTION OF THE FIGURES

Some embodiments of the present invention are now described, by way of example only, and with reference to the accompanying drawings. The same reference number represents the same element or the same type of element on all drawings.

FIG. 1 is a block diagram of an exemplary storage system.

FIG. 2 is a flowchart illustrating an exemplary process of the storage system of FIG. 1.

FIG. 3 is a block diagram illustrating exemplary storage allocation of the storage system of FIG. 1.

FIG. 4 is a table illustrating mapping of the exemplary storage allocation.

FIG. 5 is a block diagram illustrating an exemplary increase in the storage allocation.

FIG. 6 is a table illustrating an updated table of FIG. 4 after the exemplary increase in the storage allocation.

FIG. 7 is a block diagram illustrating an exemplary addressing in the storage allocation.

FIG. 8 is a flowchart illustrating another exemplary process of the storage system of FIG. 1.

FIG. 9 is a block diagram of an exemplary storage with encrypted data.

FIG. 10 is a block diagram of an exemplary computing system in which a computer readable medium provides instructions for performing methods herein.

### DETAILED DESCRIPTION

The figures and the following description illustrate specific exemplary embodiments of the invention. It will thus be appreciated that those skilled in the art will be able to devise various arrangements that, although not explicitly described or shown herein, embody the principles of the invention and are included within the scope of the invention. Furthermore, any examples described herein are intended to aid in understanding the principles of the invention and are to be construed as being without limitation to such specifically recited examples and conditions. As a result, the invention is not limited to the specific embodiments or examples described below.

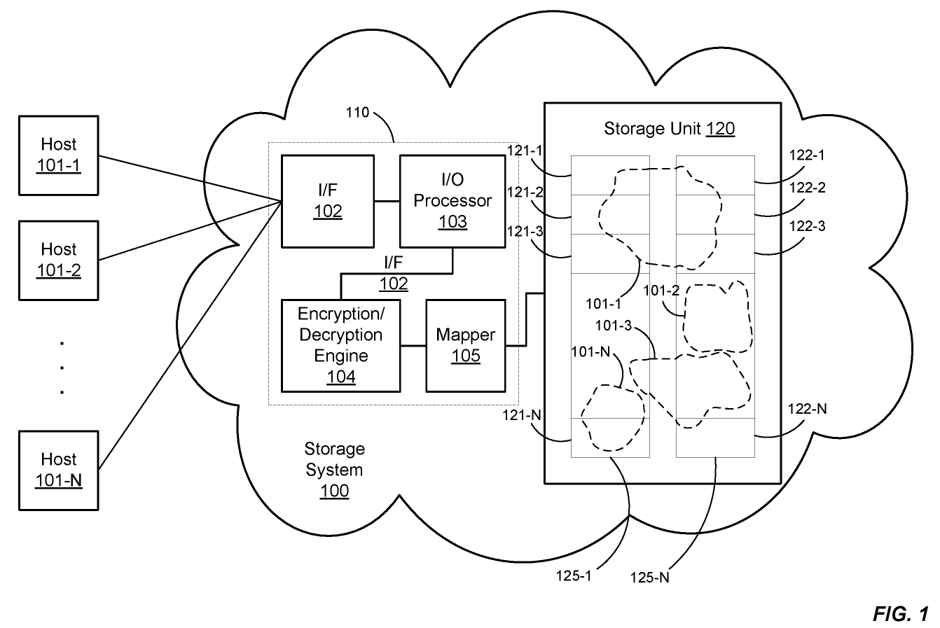

FIG. 1 is a block diagram of an exemplary storage system 100. The storage system 100 is operable to interface with and provide data storage for a plurality of host systems 101-1-101-N (where the reference number “N” merely indicates an integer greater than “1” and not necessarily equal to any other “N” reference number designated herein). In doing so, the storage system 100 allocates the host systems 101 storage space within the storage unit 120 on an as-needed basis. For example, the storage system 100 may increase the amount of data storage that a host system 101 needs based on a size of the data in a write I/O request from the host system 101. Similarly, the storage system 100 may deallocate storage space of the host system 101 when the host system 101 deletes data.

The storage system 100 comprises a storage unit 120 that stores data of the host systems 101. Typically, the storage unit 120 comprises a plurality of logical units (LUNs, also referred to as logical volumes) 125-1-125-N with each LUN comprising a plurality of logical block addresses (LBAs) (e.g., LBAs 121-1-121-N and 122-1-122-N. For example, the storage unit 120 may comprise a plurality of hard disk drives (HDDs), solid-state drives (SSDs), or some combination thereof. And, an individual storage device may represent an individual LUN within the storage unit 120. However, the invention is not intended to be limited to LUNs being configured from individual storage devices as LUNs may be configured with multiple storage devices or even portions of individual storage devices.

The storage system 100 also comprises a storage controller 110 that is operable to process I/O requests from the host systems 101 for storing data in and retrieving data from the storage unit 120. For example, the storage controller 110 may include an interface 102 that communicatively couples the storage system 100 to the host systems 101 and receives the I/O requests from the host systems 101. The I/O requests may then be processed by an I/O processor 103 of the storage controller 110 such that the I/O requests can be directed to the storage unit 120 for data storage and retrieval.

The I/O processor 103 may also identify individual host systems 101 accessing the storage unit 120. For example, to ensure that data of each individual host system 101 is secure from other host systems 101 accessing the storage unit 120, the I/O processor 103 may determine which host system 101 is accessing the storage unit 120 from its I/O request. In this regard, the storage controller 110 may include an encryption/decryption engine 104 that ensures one host system 101 cannot access data within the storage unit 120 belonging to another host system 101 (or any nefarious actors, such as “hackers”) by employing data encryption techniques on a host-by-host basis.

A mapper 105 may also be configured with the storage controller 110 to interrogate the storage unit 120 for storage allocations of the host systems 101 and to direct I/O requests to the appropriate storage locations. For example, the I/O processor 103 may receive a write I/O request from the host system 101-1 to write data to storage space in the storage unit 120 belonging to the host system 101-1. Once the data is encrypted by the encryption/decryption engine 104, the mapper 105 locates the storage space within the storage unit 120, determines whether more storage space needs to be allocated for the data of the write I/O request, and then maps the encrypted data to the storage space of the host system 101-1.

As illustrated, the storage space within the storage unit 120 is organically and dynamically allocated to the host systems 101. And, the storage space allocation to the host systems 101 does not require predetermined blocks of storage space within the storage unit 120. For example, previous storage systems would dynamically allocate storage space within a storage device by allocating predetermined blocks of storage space in 1 MB increments within a storage device. The storage system 100, however, allows each host system 101 to grow or reduce its storage space allocation on an as-needed basis. And, the storage space allocated to any particular host system 101 can span multiple LBAs and/or LUNs that the mapper 105 manages.

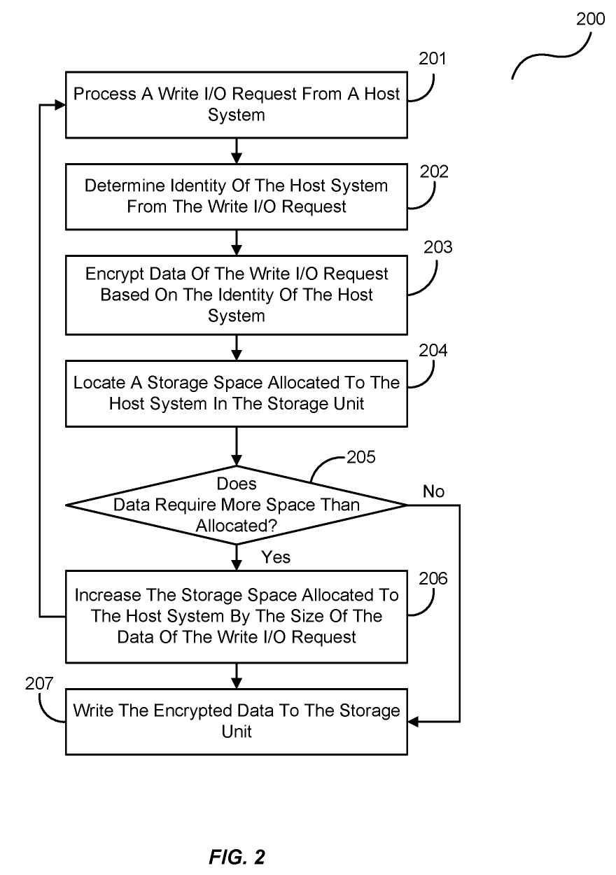

Based on the forgoing, the storage controller 110 is any device, system, software, or combination thereof operable to provide secure storage for a plurality of host systems 101 on an as-needed basis. With this in mind, one exemplary process 200 of the storage system 100 is now described with respect to the flowchart illustrated in FIG. 2. In this embodiment, the storage controller 110 processes a write I/O request from a host system 101, such as the host system 101-1, in the process element 201. From there, the storage controller 110 determines the identity of the host system 101 from the write I/O request, in the process element 202. For example, a flag or some other identifier may be implemented with the I/O request that is unique to the host 101-1. Based on that flag or identifier, the storage controller 110 determines that the write I/O request originated from the host 101-1.

Thereafter, the storage controller 110 (e.g., the encryption/decryption engine 104) encrypts the data of the write I/O request based on the identity of the host system 101, in the process element 203. For example, once the storage controller 110 identifies the host system 101-1 as the originator of the write I/O request, the storage controller 110 may encrypt the data of the write I/O request in a manner that is unique to the host system 101-1. Such may be implemented with a unique encryption/decryption key that encrypts the data based on the identity of the host system 101-1. In this regard, when the data is read by the host system 101-1 through a read I/O request, the encryption/decryption engine 104 decrypts the data according to the identity of the host system 101-1 and its unique encryption/decryption key.

To write the data, the storage controller 110 locates a storage space in the storage unit 120 allocated to the host system 101, in the process element 204. For example, the mapper 105 may interrogate the storage unit 120 through a lookup table that addresses the storage unit 120. The lookup table may include a link identifying which portion of the storage unit 120 has been allocated to the host system 101-1 and its address within the storage unit 120.

Then, the storage controller 110 determines whether the host system 101 requires more space than currently allocated, in the process element 205. For example, the mapper 105 upon locating the data of the host system 101-1 may evaluate the data of the present write I/O request to determine whether the data of the I/O request is overwriting data, deleting data, or adding data. If the write I/O request is adding data, then the mapper 105 may increase the storage space allocated to the host system 110-1 by the size of the data of the write I/O request, in the process element 206. The storage controller 110 then writes the encrypted data to the storage unit 120, in the process element 207.

If the host system 101 does not require more space than is presently allocated, then the storage controller 110 may simply write the encrypted data to the storage unit, in the process element 207. However, if the host system 101 is deleting data that was previously written, the storage controller 110 may deallocate the storage space from the storage unit 120 such that it may be used by another host system 101 (or the same host system 101) when needed.

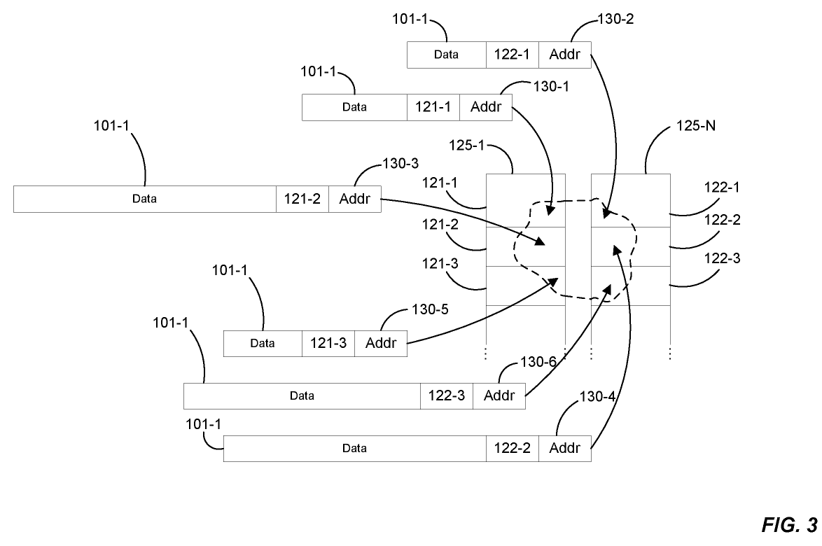

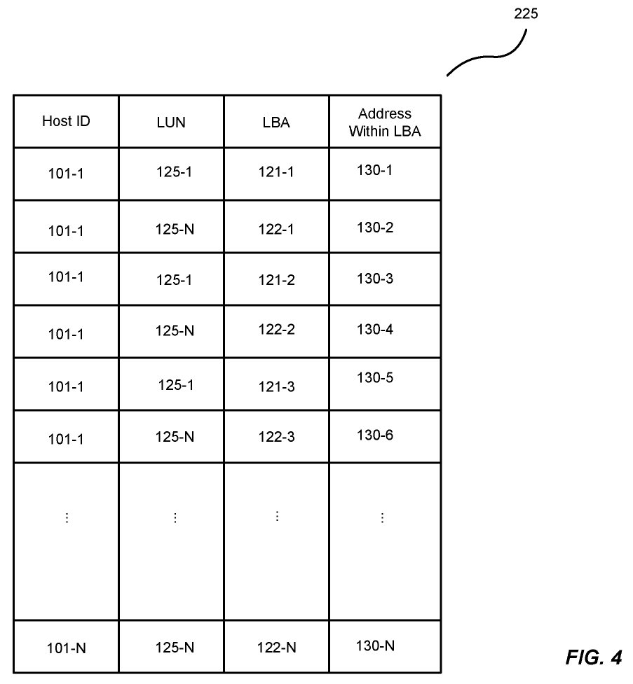

FIG. 3 is a block diagram illustrating an exemplary storage allocation of the storage system 100. In this example, FIG. 3 shows how the storage space of the host system 101-1 is presently allocated in the storage unit 120 based on its current data usage. The storage space allocated to the host system 101-1 spans across the LUNs 125-1-125-N. For example, the storage space of the host system 101-1 is allocated across the LBAs 121-1-121-3 in the LUN 125-1 and across the LBAs 122-1-122-3 in the LUN 125-N. The mapper 105 maps each chunk of data belonging to the host system 101-1 with an address 130 in each LBA 121/122 of each LUN 125. For example, the data of the host system 101-1 in the LUN 125-1 at the LBA 121-1 has an address 130-1; the data of the host system 101-1 in the LUN 125-N at the LBA 122-1 has an address 130-2; the data of the host system 101-1 in the LUN 125-1 at the LBA 121-2 has an address 130-3; and so on. Each of these chunks of data may be contiguous so as to track the data more quickly with a lookup table as illustrated in FIG. 4.

In FIG. 4, the table 225 comprises the host system 101 ID, the LUN(s) 125, the LBA(s) 121/122, and the addresses 130 where the data of the host system 101 is located in the storage unit 120. Again, using the host system 101-1 as the example, the table 225 shows that the host system 101-1 has a first chunk of data at an address 130-1 within the LUN 125-1 at the LBA 121-1, a second chunk of data at an address 130-2 within the LUN 125-N at the LBA 122-1, and so on through its sixth and last chunk of data at an address 130-6 within the LUN 125-N at the LBA 122-3. With this table 225, the mapper 105 can quickly locate data of a requesting host system 101 to retrieve, overwrite, and/or modify data of the host system 101 within the storage unit 120.

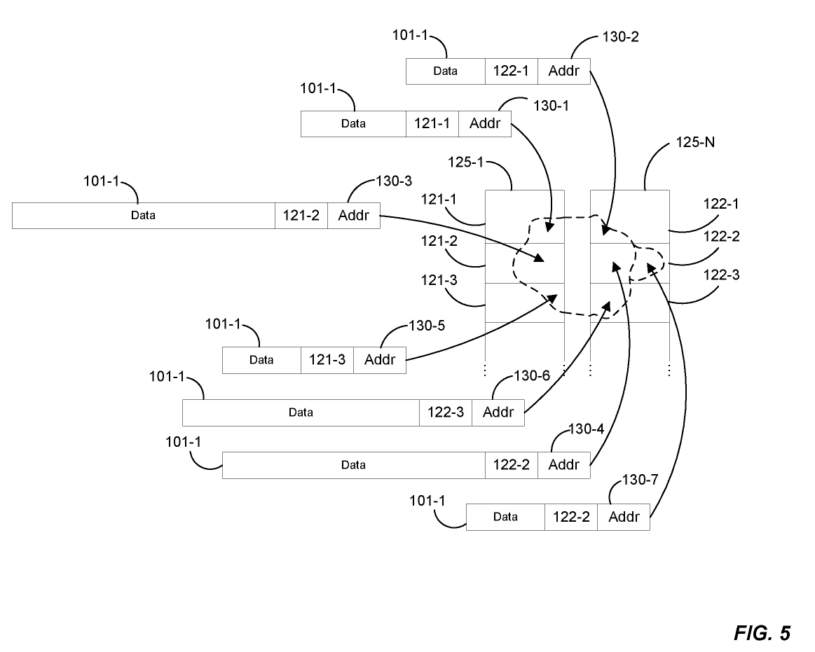

With this in mind, FIG. 5 illustrates the block diagram of FIG. 3 receiving a write I/O request by the host system 101-1 that requires an allocation of more storage space for the host system 101-1. For example, the I/O processor 103 may determine that the data of the write I/O request from the host system 101-1 is unique with respect to the data of the host system 101-1 already stored across the LUNs 125-1-125-N in the storage unit 120. And, as such, the storage controller 110 needs to allocate more storage space within the storage unit 120. Again, the encryption/decryption engine 104 encrypts the data of the write I/O requests and transfers it to the mapper 105 such that the mapper 105 can store the encrypted data and map the encrypted data to the table 225.

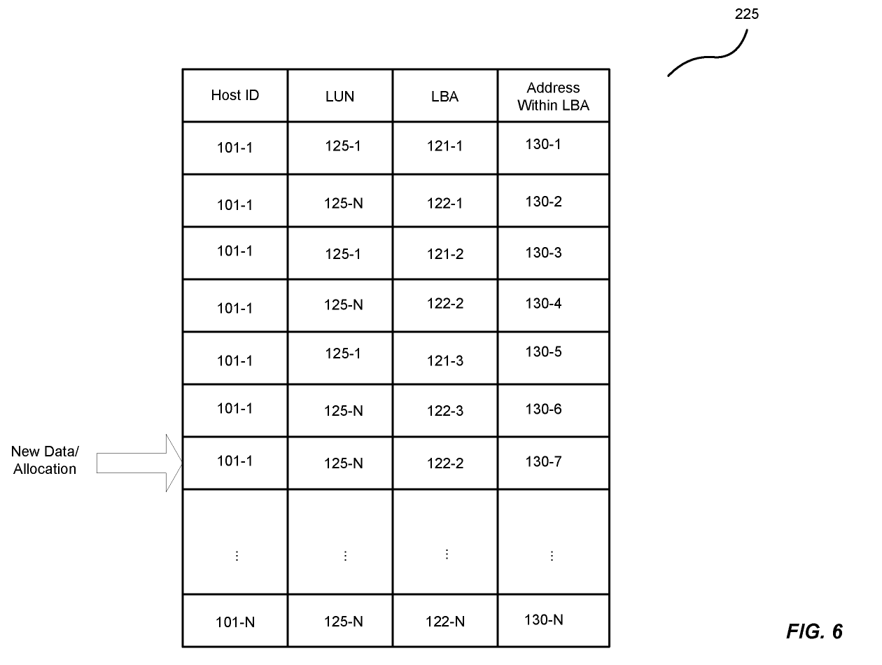

In this embodiment, the mapper 105 stores the data of the new write I/O request from the host system 101-1 in the LUN 125-N at the LBA 122-2 at an address 130-7. In doing this, the mapper 105 updates the table 225 to reflect the new data being input to the storage unit 120, as illustrated in FIG. 6.

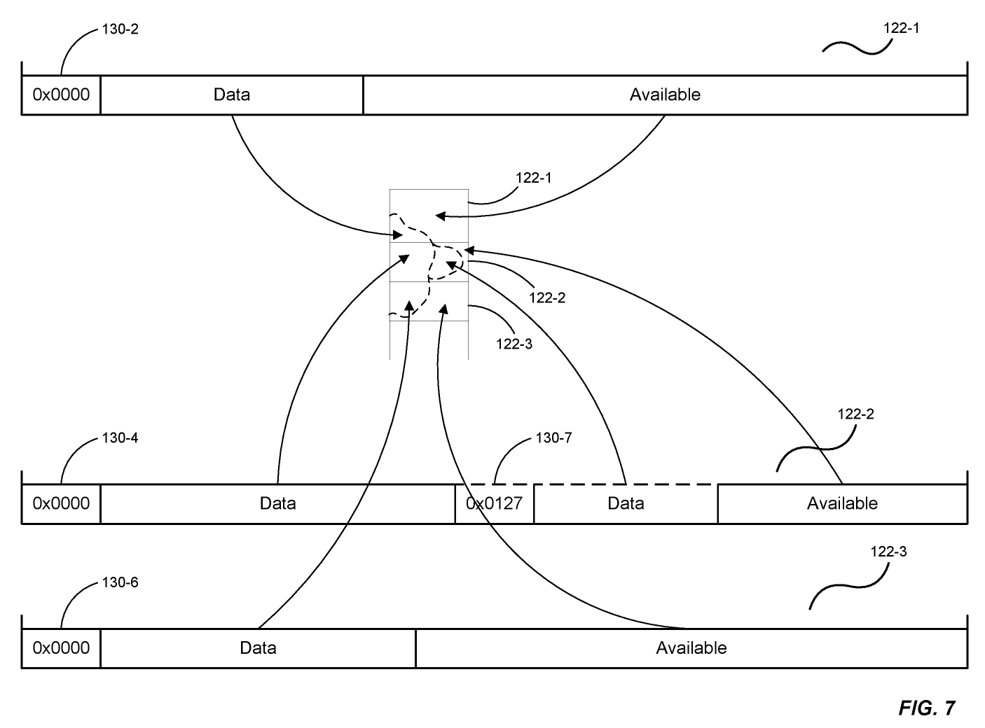

Although illustrated with respect to the data being stored in a nebulous fashion (e.g., cloudlike) across the LBAs 121-1-121-3 of the LUN 125-1 and the LBAs 122-1-122-3 of the LUN 125-N, the figures are merely intended to show how/where storage space may be allocated and data may be stored in the storage unit 120 such that the data may be tracked by the mapper 105. FIG. 7 illustrates a block diagram of an addressing scheme that may be implemented and used in the table 225 by the mapper 105. For example, focusing on the LBAs 122-1-122-3 of the LUN 125-N used by the host system 101-1, the first chunk of data in the LBA 122-1 is located at the address 0x0000 (130-2) of the LBA 122-1 in the LUN 125-N. The remainder of space at the LBA 122-1 remains available and thus unallocated.

The next chunk of data is located at the address 0x0000 (130-4) of the LBA 122-2 in the LUN 125-N. And, with the data of the new write request illustrated in FIG. 5 being placed at the same LBA 122-2 as described above, the new data is placed adjacent to the existing data at the address 0x0127 (130-7), leaving the remaining space available and unallocated in the LBA 122-2 of the LUN 125-N. And, the data of the host system 101-1 in the LBA 122-3 of the LUN 125-N is located at the address 0x0000 (130-6) of the LBA 122-3, leaving the remaining space available and unallocated in the LBA 122-3 of the LUN 125-N.

Although mentioned with respect to the data of the host system 101-1 being contiguous throughout the LBAs 121-1, 122-1, 121-2, . . . 122-3 of the LUNs 125-1 and 125-N, the invention is not intended to be limited as such. Rather, this example was used to assist the reader in understanding how data of one host system 101 is not pre-allocated or allocated in predetermined sized chunks. Instead, the data of any particular host system 101 may be allocated within the storage unit 120 across the LBAs 121/122 of the LUNs 125-1-125-N in any of a variety ways as a matter of design choice. For example, the host system 101-1 may have storage space allocated within the LBA 121-1 of the LUN 125-1 with associated/contiguous data stored at the LBA 122-N of the LUN 125-N with no other data or storage space allocated in between.

Again, the storage controller 110 is operable to determine from the write I/O request whether storage space of the storage unit 120 is to be allocated or deallocated to a host system 101. For example, if the write I/O request from a host system 101 is being used to store completely new data (i.e., not having storage space allocated yet), then the storage controller 110 processes the write I/O request, encrypts the data of the write I/O request, allocates storage space within the storage unit 120 based on the amount of data being written, and then maps/stores the encrypted data in the storage unit 120. However, if the write I/O request from the host system 101 is being used to merely modify stored data in the storage unit 120 (e.g., not requiring additional storage space or deallocation of storage space), then the storage controller 110 may locate the existing data within the storage unit 120, and overwrite the existing data with the newly encrypted data of the write I/O request.

And, if the write I/O request from a host system is operable to remove data from the storage unit 120, then the storage controller 110 locates the data within the storage unit 120 and clears that data (e.g., by writing all logical “0s” or all logical “1s” to the storage space). In doing so, the storage controller 110 deallocates the storage space from the host system 101 such that it may be used by another host system 101 (or the same host system 101) later on. In other words, storage space within the storage unit 120 may be allocated to the host systems 101 based on the individual I/O requests of the host systems 101 in that the size of the data of the I/O requests largely determines the storage space allocations.

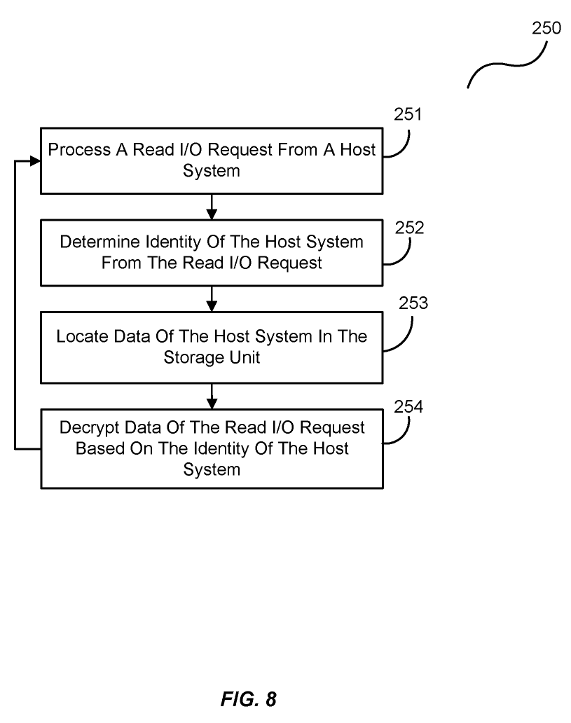

FIG. 8 is a flowchart illustrating another exemplary process 250 of the storage system 100. In this embodiment, the process 250 at least partially illustrates how data of each host system 101 is secured within the storage unit 120 of the storage system 100. For example, data of each host system 101 is stored within the storage unit 120 using a unique encryption key. In other words, the host system 101-1 upon being identified with its I/O request has its data encrypted with a key that is unique to the host system 101-1. The host system 101-1 then has its encrypted data stored within the storage unit 120 and mapped as described above. A second host system 101-2 would have its data encrypted and stored within the storage unit 120 in a similar manner using an encryption key that is unique to the host system 101-2.

In this regard, the storage controller 110 processes a read I/O request from a host system 101, in the process element 251. To simplify discussion, the process 250 will again be discussed with respect to the example of the host system 101-1. Thus, the storage controller 110, in processing the read I/O request of the host system 101-1 determines the identity of the host system 101-1 from the read I/O request, in the process element 252. Then, the storage controller 110 locates the data of the read I/O request from the host system 101-1 in the storage unit 120 based on the mapping described above, in the process element 253. Once the data is located, the storage controller 110 uses the encryption/decryption key associated with the host system 101-1 to decrypt the data pertaining to the read I/O request, in the process element 254. The storage controller 110 delivers the decrypted data to the host system 101-1 and the process 250 returns to the process element 251 for the next I/O request (e.g., a read I/O request or a write I/O request although illustrated with respect to a read I/O request for the purposes of simplicity).

Again, each host system 101 may be assigned a unique encryption/decryption key. However, the encryption/decryption key is generally maintained with the storage controller 110 in the storage system 100 to prevent unauthorized users from obtaining the encryption/decryption key from the host system 101. In other words, a host system 101 accessing its allocated data storage in the storage unit 120 is first identified and then its data is encrypted and written (or decrypted and read) based on its unique encryption/decryption key maintained within the storage system 100.

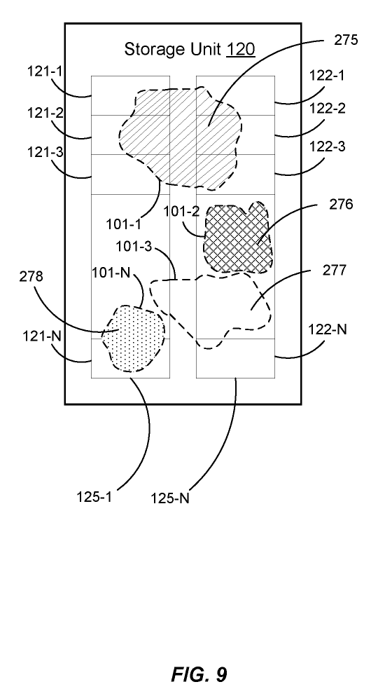

To illustrate, FIG. 9 shows the storage unit 120 with the storage allocations to the host systems 101-1, 101-2, 101-3, and 101-N. The data of the host system 101-1 is encrypted with an encryption key 275. The data of the host system 101-2 is encrypted with an encryption key 276. The data of the host system 101-3 is encrypted with an encryption key 277. And, the data of the host system 101-N is encrypted with an encryption key 278. Once encrypted with their respective encryption keys, one host system 101 is unable to decrypt the data of another host system 101.

For example, once the host system 101-1 has its data encrypted with the encryption key 275, that data cannot be decrypted by another host system 101 even if the other host system 101 inadvertently accesses the allocated storage space of the host system 101-1. Instead, even if the other host system were to inadvertently access the allocated storage space of the host system 101-1 and once the other host system 101 is identified, the storage controller 110 would attempt to decrypt the data of the host system 101-1 with the encryption/decryption key of the other host system 101. To illustrate, if the host system 101-2 attempts to access the storage space of the host system 101-1, the storage controller 110 would attempt to decrypt the data of the host system 101-1 with the decryption key of the host system 101-2 as the keys are dependent upon identification of the host systems. Accordingly, the data of the host system 101-1, even if retrievable, would appear as encrypted data to the host system 101-2 as it would be decrypted with the incorrect decryption key.

The systems and methods used to perform the encryption/decryption of the various host systems 101 may be implemented as a matter of design choice. For example, encryption/decryption keys may be “hot assigned” such that they may be mapped to a specific host by a media access control (MAC) address, a granular solution that in any case prevents unintended host systems 101 from accessing a data space. Unique user IDs could also be assigned which provides an additional level of protocol but ensures that groups of host systems 101 can properly address their respective data spaces. For example, one host system 101 may have multiple users. The storage controller 110 may maintain multiple encryption keys for that host system 101 such that each user's data of that host system is secure from other users of the host system 101 as well as from other host systems 101.

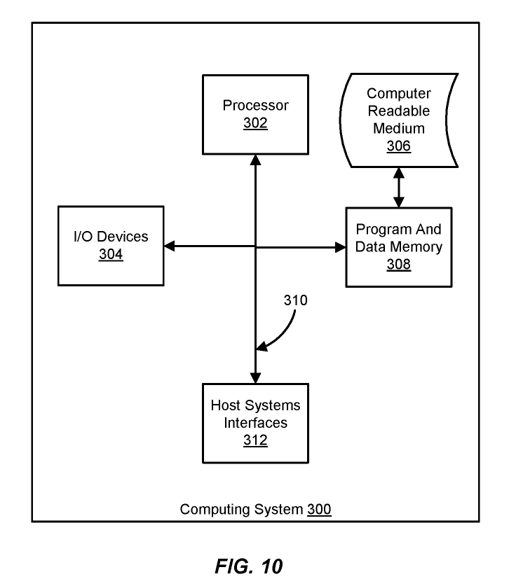

The invention can take the form of an entirely hardware embodiment, an entirely software embodiment or an embodiment containing both hardware and software elements. In one embodiment, the invention is implemented in software, which includes but is not limited to firmware, resident software, microcode, etc. FIG. 10 illustrates a computing system 300 in which a computer readable medium 306 may provide instructions for performing any of the methods disclosed herein.

Furthermore, the invention can take the form of a computer program product accessible from the computer readable medium 306 providing program code for use by or in connection with a computer or any instruction execution system. For the purposes of this description, the computer readable medium 306 can be any apparatus that can tangibly store the program for use by or in connection with the instruction execution system, apparatus, or device, including the computer system 300.

The medium 306 can be any tangible electronic, magnetic, optical, electromagnetic, infrared, or semiconductor system (or apparatus or device). Examples of a computer readable medium 306 include a semiconductor or solid state memory, magnetic tape, a removable computer diskette, a random access memory (RAM), a read-only memory (ROM), a rigid magnetic disk and an optical disk. Some examples of optical disks include compact disk-read only memory (CD-ROM), compact disk-read/write (CD-R/W) and DVD.

The computing system 300, suitable for storing and/or executing program code, can include one or more processors 302 coupled directly or indirectly to memory 308 through a system bus 310. The memory 308 can include local memory employed during actual execution of the program code, bulk storage, and cache memories which provide temporary storage of at least some program code in order to reduce the number of times code is retrieved from bulk storage during execution. Input/output or I/O devices 304 (including but not limited to keyboards, displays, pointing devices, etc.) can be coupled to the system either directly or through intervening I/O controllers. Network adapters may also be coupled to the system to enable the computing system 300 to become coupled to other data processing systems, such as through host systems interfaces 312, or remote printers or storage devices through intervening private or public networks. Modems, cable modem and Ethernet cards are just a few of the currently available types of network adapters.

What is claimed is:

1. A storage system operable to interface with a plurality of host systems, the storage system comprising:
a storage unit; and
a controller operable to process a write Input/Output (I/O) request from a first of the host systems, to determine an identity of the first host system from the write I/O request, to encrypt data of the write I/O request based on the identity of the first host system, to locate a storage space allocated to the first host system in the storage unit, to determine that a size of the data of the write I/O request requires more storage space than currently allocated to the first host system, to increase the storage space allocated to the first host system by the size of the data of the write I/O request, and to write the encrypted data to the storage unit.

2. The storage system of claim 1, wherein:
the storage system comprises a plurality of logical volumes, with each logical volume comprising a plurality of logical block addresses (LBAs); and
the storage space of the first host system spans at least two of the LBAs of the storage unit.

3. The storage system of claim 2, wherein:
the storage space of the first host system spans at least two of the logical volumes of the storage unit.

4. The storage system of claim 1, wherein:
the controller is further operable to process a read I/O request from the first host system for the encrypted data, and to decrypt the data based on the identity of the first host system.

5. The storage system of claim 1, wherein:
the controller is further operable to process a read I/O request from a second of the host systems for the encrypted data of the first host system, and to decrypt the data based on the identity of the second host system; and
the decrypted data is unintelligible to the second host system.

6. The storage system of claim 1, wherein:
the storage unit comprises a hard disk drive, a solid state drive, or a combination thereof.

7. The storage system of claim 1, wherein:
the storage controller is further operable to maintain at least one encryption key for each host system, and to encrypt the data of the write I/O request using an encryption key of the first host system when the identity of the first host system is determined.

8. A method of data storage for a plurality of host systems, the method comprising:
processing a write Input/Output (I/O) request from a first of the host systems;
determining an identity of the first host system from the write I/O request;
encrypting data of the write I/O request based on the identity of the first host system;
locating a storage space allocated to the first host system in the storage unit;
determining that a size of the data of the write I/O request requires more storage space than currently allocated to the first host system;
increasing the storage space allocated to the first host system by the size of the data of the write I/O request; and
writing the encrypted data to the storage unit.

9. The method of claim 8, wherein:
the storage system comprises a plurality of logical volumes, with each logical volume comprising a plurality of logical block addresses (LBAs); and
the storage space of the first host system spans at least two of the LBAs of the storage unit.

10. The method of claim 9, wherein:
the storage space of the first host system spans at least two of the logical volumes of the storage unit.

11. The method of claim 8, further comprising:
processing a read I/O request from the first host system for the encrypted data; and
decrypting the data based on the identity of the first host system.

12. The method of claim 8, further comprising:
processing a read I/O request from a second of the host systems for the encrypted data of the first host system; and
decrypting the data based on the identity of the second host system, wherein the decrypted data is unintelligible to the second host system.

13. The method of claim 8, wherein:
the storage unit comprises a hard disk drive, a solid state drive, or a combination thereof.

14. The method of claim 8, further comprising:
maintaining at least one encryption key for each host system; and
encrypting the data of the write I/O request using an encryption key of the first host system when the identity of the first host system is determined.

15. A non-transitory computer readable medium comprising instructions that, when executed by a processor in a storage system, are operable to direct the processor to store data for a plurality of host systems, the computer readable medium further comprising instructions that direct the processor to:
process a write Input/Output (I/O) request from a first of the host systems;
determine an identity of the first host system from the write I/O request;
encrypt data of the write I/O request based on the identity of the first host system;
locate a storage space allocated to the first host system in the storage unit;
determine that a size of the data of the write I/O request requires more storage space than currently allocated to the first host system;
increase the storage space allocated to the first host system by the size of the data of the write I/O request; and
write the encrypted data to the storage unit.

16. The computer readable medium of claim 15, wherein:
the storage system comprises a plurality of logical volumes, with each logical volume comprising a plurality of logical block addresses (LBAs); and
the storage space of the first host system spans at least two of the LBAs of the storage unit.

17. The computer readable medium of claim 16, wherein:
the storage space of the first host system spans at least two of the logical volumes of the storage unit.

18. The computer readable medium of claim 15, further comprising instructions that direct the processor to:
process a read I/O request from the first host system for the encrypted data; and
decrypt the data based on the identity of the first host system.

19. The computer readable medium of claim 15, further comprising instructions that direct the processor to:
process a read I/O request from a second of the host systems for the encrypted data of the first host system; and
decrypt the data based on the identity of the second host system, wherein the decrypted data is unintelligible to the second host system.

20. The computer readable medium of claim 15, further comprising instructions that direct the processor to:
maintain at least one encryption key for each host system; and
encrypt the data of the write I/O request using an encryption key of the first host system when the identity of the first host system is determined.
